(19) United States
(12) Patent Application Publication
(10) Pub. No.: US 2012/0313040 A1
(43) Pub. Date: Dec. 13, 2012

(54) COATING LIQUID, OPTICAL ANISOTROPIC FILM AND IMAGE DISPLAY DEVICE

(75) Inventor: Hisanari ONOUCHI, Osaka (JP)

(73) Assignee: NITTO DENKO CORPORATION, Osaka (JP)

(21) Appl. No.: 13/488,649

(22) Filed: Jun. 5, 2012

(30) Foreign Application Priority Data
Jun. 10, 2011 (JP) 2011-129864

(51) Int. Cl. C09K 19/06; C09K 19/34; C09K 19/32

(52) U.S. Cl. 252/299.61; 252/299.6; 252/299.62

(57) ABSTRACT

A coating liquid comprising: a lyotropic liquid crystalline compound having a π-conjugated system planar skeleton moiety and one or plural nitrogen-containing heterocyclic cation moiety or nitrogen-containing heteroaromatic cation moiety bonded to the planar skeleton moiety; and a solvent, an optical anisotropic film obtained by applying the coating liquid on a developing surface to form a coated film and solidifying this coated film, and an image display device provided with the optical anisotropic film are disclosed.

### TECHNICAL FIELD

The present invention relates to a coating liquid which can be utilized as a forming material of an optical film, and an optical anisotropic film formed using this coating liquid and an image display device provided with this optical anisotropic film.

### BACKGROUND ART

As a method for producing an optical anisotropic film, there has hitherto been known a method of applying on a developing surface a coating liquid obtained by dissolving a compound that shows liquid crystallinity in a solution state in a solvent to from a coated film, and solidifying the coated film (a so-called solution casting method). Such a compound is also called a lyotropic liquid crystalline compound.

Since the lyotropic liquid crystalline compound forms a columnar structure (supramolecular aggregate) in the coating liquid, a film obtained by solidifying the coated film containing this compound can be utilized as a polarizing film and the like.

The above lyotropic liquid crystalline compound has a π-conjugated system planar skeleton moiety in its molecule. In the solution state, plural lyotropic liquid crystalline compound molecules form a columnar structure by stacking of the planar skeleton moieties thereof on one another.

However, the lyotropic liquid crystalline compound has the π-conjugated system planar skeleton moiety, so that it has low solubility in a solvent.

Non-Patent Document 1 discloses that in order to improve solvent solubility of a lyotropic liquid crystalline compound having a planar skeleton moiety such as a perylene-based skeleton, the terminal end of the planar skeleton moiety is substituted with a long-chain alkyl group having a polar group such as a COOH group.

However, introduction of such a long-chain alkyl group causes a possibility of inhibiting the above stacking of the planar skeleton moieties. For this reason, the coating liquid containing the lyotropic liquid crystalline compound in which a long-chain alkyl group is introduced does not form a good columnar structure in some cases.

Patent Document 1 discloses a lyotropic liquid crystalline compound having a planar skeleton moiety such as a perylene-based skeleton and a sulfonic acid group. Such a compound is excellent in solubility in an aqueous solvent because of the presence of the sulfonic acid group. Such a sulfonic acid group-containing lyotropic liquid crystalline compound is synthesized by treating a perylene-based compound or the like with fuming sulfuric acid or concentrated sulfuric acid.

However, the above sulfuric acid treatment requires attention to handling of sulfuric acid. Further, it is difficult to introduce a sulfonic acid group into a specific position of the planar skeleton moiety. Thus, the sulfonic acid group-containing lyotropic liquid crystalline compound has a problem that synthesis thereof is complicated.

### SUMMARY OF THE INVENTION

An object of the present invention is to provide a coating liquid which forms a good columnar structure, by using a lyotropic liquid crystalline compound excellent in solvent solubility.

In the first aspect, the present invention is directed to a coating liquid comprises:

a lyotropic liquid crystalline compound having a π-conjugated system planar skeleton moiety and one or plural nitrogen-containing heterocyclic cation moiety or nitrogen-containing heteroaromatic cation moiety bonded to the planar skeleton moiety; and a solvent.

The coating liquid according to the present invention, it is preferred that the nitrogen-containing heterocyclic cation moiety or nitrogen-containing heteroaromatic cation moiety has a nitrogen atom having a conjugated double bond and constituting a heterocyclic ring as a cation.

The coating liquid according to the present invention, it is preferred that an alkyl group is bonded to the nitrogen cation constituting the heterocyclic ring of the nitrogen-containing heterocyclic cation moiety or nitrogen-containing heteroaromatic cation moiety. The alkyl group preferably has from 1 to 4 carbon atoms.

The coating liquid according to the present invention, it is preferred that the one or plural nitrogen-containing heterocyclic cation moiety or nitrogen-containing heteroaromatic cation moiety is bonded to an end portion of the π-conjugated system planar skeleton moiety.

The coating liquid according to the present invention, it is preferred that the nitrogen-containing heterocyclic cation moiety or nitrogen-containing heteroaromatic cation moiety forms a part of the π-conjugated system planar skeleton moiety to expand the π-conjugated system planar skeleton moiety.

In the second aspect, the present invention is directed to an optical anisotropic film obtained by applying any of the above coating liquid on a developing surface to form a coated film and solidifying this coated film.

In the third aspect, the present invention is directed to an image display device provided with the above optical anisotropic film as a constituent member thereof.

In a coating liquid of the present invention, since a lyotropic liquid crystalline compound is well dissolved in a solvent, plural lyotropic liquid crystalline compound molecules form a good columnar structure. In a coated film formed from such a coating liquid, the lyotropic liquid crystalline compound is well oriented, and an optical anisotropic film can be formed from this coated film.

### BRIEF DESCRIPTION OF THE DRAWINGS

FIG. 1 is a partial cross-sectional view showing an optical anisotropic film according to one embodiment of the present invention.

FIG. 2 is a partial cross-sectional view showing a polarizing plate according to one embodiment of the present invention.

### DESCRIPTION OF REFERENCE NUMERALS AND SIGNS

1: Optical anisotropic film
2: Base material
3: Protective film
5: Polarizing plate

### DETAILED DESCRIPTION OF THE INVENTION

### [Coating Liquid]

A coating liquid of the present invention includes a lyotropic liquid crystalline compound and a solvent.

The lyotropic liquid crystalline compound is a compound having a property of causing phase transition between an isotropic phase and a liquid crystal phase in a liquid by changing liquid temperature, compound concentration or the like.

The coating liquid of the present invention forms the liquid crystal phase by formation of a columnar structure (supramolecular aggregate) of the lyotropic liquid crystalline compound. The above coating liquid is suitable, for example, as a material for forming an optical anisotropic film such as a polarizing film, or an organic semiconductor layer of an organic electronic element.

Incidentally, in the present specification, the description “from XXX to YYY” means “XXX or more and YYY or less”. Further, in the present specification, the description “substituted or unsubstituted” means “having a substituent or having no substituent”.

### (Lyotropic Liquid Crystalline Compound)

The lyotropic liquid crystalline compound used in the present invention is a compound having π-conjugated system planar skeleton moiety and one or plural nitrogen-containing heterocyclic cation moiety or nitrogen-containing heteroaromatic cation moiety bonded to the planar skeleton moiety, in its molecule.

Incidentally, before dissolved in a solvent, the lyotropic liquid crystalline compound is stabilized in a salt form in which an arbitrary anion is electrostatically bonded thereto. The salt of the above lyotropic liquid crystalline compound is ionized to form a cation by dissolving the lyotropic liquid crystalline compound in a solvent.

The above π-conjugated system planar skeleton moiety has a ring structure with single bonds and double bonds alternately arranged. The “π-conjugated system planar skeleton moiety” is hereinafter simply referred to as “planar skeleton moiety” in some cases.

The planar skeleton moiety-containing lyotropic liquid crystalline compounds produce a π-stack in which planar skeleton moieties are stacked one another, by dissolving plural molecules thereof in a solvent, to thereby form a stable columnar structure.

The planar skeleton moieties include a benzene ring, a condensed aromatic ring in which two or more benzene rings are condensed with each other, a polycyclic condensed aromatic ring in which two or more condensed aromatic rings are bonded to each other, an unsaturated heterocyclic ring, a condensed heterocyclic ring in which two or more unsaturated heterocyclic rings are condensed with each other, a condensed heteroaromatic ring in which one or more benzene rings or one or more condensed aromatic rings is condensed with one or more heterocyclic rings, and a polycyclic condensed heteroaromatic ring in which one or more benzene rings or one or more condensed aromatic rings is bonded to one or more condensed heterocyclic rings.

The condensed aromatic rings in which one or more benzene rings are condensed with each other, include naphthalenes shown in formula (1c), anthracenes, phenanthrenes, pyrenes, and triphenylenes.

The polycyclic condensed aromatic rings in which two or more condensed aromatic rings are bonded to each other, include perylenes shown in formula (1a) and ones shown in formula (1b).

The condensed heterocyclic rings in which two or more unsaturated heterocyclic rings are condensed with each other, include purines and naphthyridines.

The condensed heteroaromatic rings in which one or more benzene rings or one or more condensed aromatic rings is condensed with one or more heterocyclic rings, include indoles, benzimidazoles, quinolines, quinoxalines, carbazoles, and xanthenes.

The above nitrogen-containing heterocyclic cation moiety or nitrogen-containing heteroaromatic cation moiety has a positive charge, and at least one of the atoms constituting the heterocyclic ring is nitrogen atom. The heterocyclic ring may contain a heteroatom other than the nitrogen atom as long as the heterocyclic ring contains nitrogen atom as a constituent atom thereof. Further, although the heterocyclic ring may be a 3-membered to 10-membered ring or a condensed ring thereof, a 5-membered or 6-membered ring or a condensed ring thereof is preferred above all.

The “nitrogen-containing heterocyclic cation moiety” is hereinafter referred to as the “heterocyclic cation moiety”, and the “nitrogen-containing heteroaromatic cation moiety” is hereinafter referred to as the “heteroaromatic cation moiety”, in some cases.

The heterocyclic ring constituting the above heterocyclic cation moiety or heteroaromatic cation moiety may be either saturated or unsaturated. Of course, since it is possible to develop π-conjugation, integrally with the planar skeleton moiety, the heterocyclic ring constituting the heterocyclic cation moiety or heteroaromatic cation moiety preferably has an unsaturated heterocyclic ring (heterocyclic ring having a conjugated double bond).

The valence of the heterocyclic cation moiety or heteroaromatic cation moiety is 1 or more, preferably from 1 to 4, and more preferably 1 or 2.

Although the cationic species of the above heterocyclic cation moiety or heteroaromatic cation moiety is not particularly limited, the cationic species is preferably nitrogen atom constituting the heterocyclic ring, because solvent solubility can be enhanced. When the plural nitrogen atoms constituting the heterocyclic ring are present in the heterocyclic ring, preferably, at least one nitrogen atom thereof is a cation, and more preferably, one nitrogen atom thereof is a cation. The nitrogen atom forming a cation is tertiary or quaternary.

The above-mentioned one or plural heterocyclic cation moiety or heteroaromatic cation moiety may be bonded to a center portion of the planar skeleton moiety or may be bonded to an end portion of the planar skeleton moiety. The one or plural heterocyclic cation moiety or heteroaromatic cation moiety is preferably bonded to at least one end portion of the planar skeleton moiety, and more preferably bonded to at least both end portions of the planar skeleton moiety, because it is possible to make the heterocyclic cation moiety or heteroaromatic cation moiety function as an extended moiety of π-conjugated system.

When the planar view shape of the lyotropic liquid crystalline compound is rectangular, the one or plural heterocyclic cation moiety or heteroaromatic cation moiety is preferably bonded to at least one longitudinal end portion of the planar skeleton moiety, and more preferably bonded to at least both longitudinal end portions thereof.

The heterocyclic cation moiety or heteroaromatic cation moiety may be bonded to the planar skeleton moiety with a single bond or with two or more independent binding portions. The heterocyclic cation moiety or heteroaromatic cation moiety can form a part of the planer skeleton moiety by bonding the heterocyclic cation moiety or heteroaromatic cation moiety to the planar skeleton moiety with two or more independent binding portions. Accordingly, since the heterocyclic cation moiety or heteroaromatic cation moiety can expand the π-conjugated system planar skeleton moiety, integrally with the planar skeleton moiety, it is preferred that the heterocyclic cation moiety or heteroaromatic cation moiety is bonded to the planar skeleton moiety with two or more independent binding portions.

The heterocyclic rings constituting the heterocyclic cation moiety include pyrrole, imidazole, pyrazole, imidazoline, pyridine, pyrimidine, pyrazine, triazine, purine, and naphthidine. These heterocyclic rings may have a substituent or no substituent.

The heteroaromatic rings constituting the heteroaromatic cation moiety include benzimidazole, benzoxazole, indole, isoindole, quinoline, isoquinoline, quinazoline, quinoxaline, cinnoline, and acridine. These heteroaromatic rings may have a substituent or no substituent.

The lyotropic liquid crystalline compound as described above includes, for example, compounds represented by the following formulae (1a), (1b), (1c), and (1d). The lyotropic liquid crystalline compounds represented by these formulae have high planarity, although a chemical structure of the planar skeleton moiety thereof is simple. Further, since the lyotropic liquid crystalline compounds represented by these formulae have a nitrogen cation at the end portion of the planar skeleton moiety, they are excellent in solvent solubility and moreover have a structure that the planar skeleton moieties are liable to stack in the solution state.

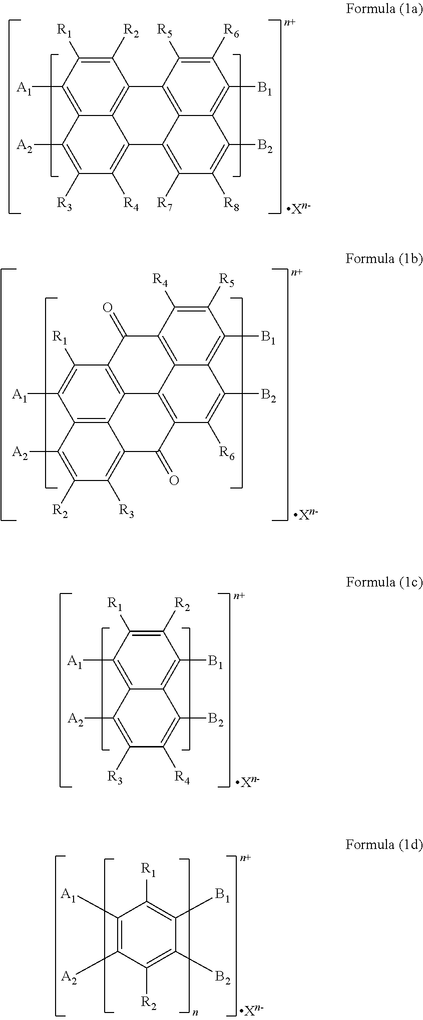

In the formulae, R₁ to R₈ each independently represents a hydrogen atom, a substituted or unsubstituted alkyl group (this alkyl group preferably has from 1 to 4 carbon atoms), a substituted or unsubstituted alkoxy group (this alkoxy group preferably has from 1 to 4 carbon atoms), an acetyl group, a carbonyl group, a halogen atom, a substituted or unsubstituted ester group (this ester group preferably has from 1 to 4 carbon atoms), an amide group, an allyloxy group, or an allyl group, n represents an integer of from 1 to 4, and Xⁿ⁻ represents an anion acting as a counter ion.

A₁ and A₂ represents that the group represented by formula (2a) or (2b) is bonded thereto to form a 5-membered or 6-membered ring.

B₁ and B₂ represents that the group represented by formula (2a), (2b) or (2c) is bonded thereto to form a 5-membered or 6-membered ring, or B₁ represents R₉ and B₂ represents R₁₀. The R₉ and R₁₀ each independently represents a hydrogen atom, a substituted or unsubstituted alkyl group (this alkyl group preferably has from 1 to 4 carbon atoms), a substituted or unsubstituted alkoxy group (this alkoxy group preferably has from 1 to 4 carbon atoms), an acetyl group, a carbonyl group, a halogen atom, a substituted or unsubstituted ester group (this ester group preferably has from 1 to 4 carbon atoms), an amide group, an allyloxy group or an allyl group.

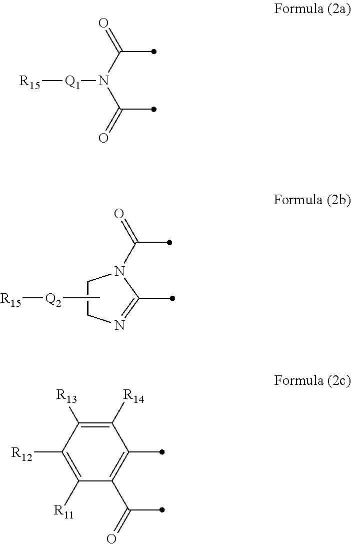

In the formulae, Q₁ and Q₂ each independently represents a substituted or unsubstituted pyridinium, a substituted or unsubstituted pyrimidinium, a substituted or unsubstituted pyrazinium, a substituted or unsubstituted quinolinium, a substituted or unsubstituted isoquinolinium, a substituted or unsubstituted acridinium, a substituted or unsubstituted quinazolinium, a substituted or unsubstituted quinoxalinium, a substituted or unsubstituted imidazolium, a substituted or unsubstituted benzimidazolium, a substituted or unsubstituted indolium, or a substituted or unsubstituted triazinium. Q₂ may form a ring integral with the imidazoline ring to which it is bonded.

R₁₅ represents a hydrogen atom, an alkyl group or an aryl group, which is bonded to the nitrogen cation of Q₁ or Q₂.

R₁₁ to R₁₄ each independently represents a hydrogen atom, a substituted or unsubstituted alkyl group (this alkyl group preferably has from 1 to 4 carbon atoms), a substituted or unsubstituted alkoxy group (this alkoxy group preferably has from 1 to 4 carbon atoms), an acetyl group, a carbonyl group, a halogen atom, a substituted or unsubstituted ester group (this ester group preferably has from 1 to 4 carbon atoms), an amide group, an allyloxy group, or an allyl group.

Since the stacking of the planar skeleton moieties is hardly inhibited, R₁ to R₁₄ in the respective formulae are preferably a hydrogen atom, an unsubstituted alkyl group having from 1 to 4 carbon atoms, an unsubstituted alkoxy group having from 1 to 4 carbon atoms, an acetyl group, a carbonyl group, a halogen atom, an unsubstituted ester group having from 1 to 4 carbon atoms, or an amide group. Since it is not bulky, R₁ to R₁₄ in the respective formulae are more preferably a hydrogen atom or halogen atom.

Further, in formula (1a), R₁, R₃, R₆ and R₈ are preferably a hydrogen atom.

In formulae (2a) and (2b), R₁₅ is preferably a hydrogen atom or an alkyl group having from 1 to 4 carbon atoms, more preferably a straight-chain alkyl group having from 1 to 4 carbon atoms, and particularly preferably an alkyl group having 1 or 2 carbon atoms.

In formulae (1a) to (1d), n is preferably 1 or 2, and more preferably 2.

In formulae (1a) to (1d), Xⁿ⁻ is not particularly limited as long as it is an anion acting as a counter ion of the nitrogen cation. Examples of the counter ions include monovalent anions such as halogen ion (e.g., chloride ion), chlorate ion, tetrafluoroboric acid ion, carboxylic acid ion, alkylcarboxylic acid ion, hydroxide ion, cyanide ion, nitrate ion, and hydrogen carbonate ion; divalent anions such as sulfonate ion, carbonate ion and sulfide ion; and trivalent anions such as phosphonate ion. Incidentally, when the cation of formulae (1a) to (1d) is divalent or more and Xⁿ⁻ is a monovalent anion, Xⁿ⁻ whose number corresponds to the valence of the cation may be electrostatically bonded to one compound. Further, when the cation of formulae (1a) to (1d) is monovalent and Xⁿ⁻ is a divalent or more anion, Xⁿ⁻ may be electrostatically bonded to the cation of formulae (1a) to (1d) and other cations in the solution to be stabilized, or may be electrostatically bonded to plural cations of formulae (1a) to (1d) in the solution to be stabilized. Incidentally, two or more kind of Xⁿ⁻ may be present in the solution.

When Q₂ does not form a ring integral with the imidazoline ring of formula (2b), Q₂ is bonded to either one of two carbon atoms of the imidazoline ring with a single bond.

When pyridinium or the like of Q₁ and Q₂ has a substituent, examples of the substituent include an alkyl group having from 1 to 4 carbon atoms, an alkoxy group having from 1 to 4 carbon atoms, a thioalkyl group having from 1 to 4 carbon atoms, a hydroxyalkyl group having from 1 to 4 carbon atoms such as a dihydroxypropyl group, an alkylamino group having from 1 to 4 carbon atoms, a halogeno group, a nitro group, a cyano group, an amino group, an acetamido group, a hydroxyl group, a sulfonate group such as a SO₃M group, and a carboxyl group such as a COOM group. Here, “M” represents an arbitrary cation.

In formulae (2a) and (2b), Q₁ and Q₂ are each independently preferably a substituted or unsubstituted pyridinium, a substituted or unsubstituted pyrimidinium, or a substituted or unsubstituted pyrazinium, and more preferably unsubstituted pyridinium, unsubstituted pyrimidinium or unsubstituted pyrazinium.

Specific examples of formula (2a) having such Q₁ are represented, for example, by formulae (2a-1) to (2a-3).

Further, specific examples of formula (2b) having such Q₂ are represented, for example, by formulae (2b-1) to (2b-3).

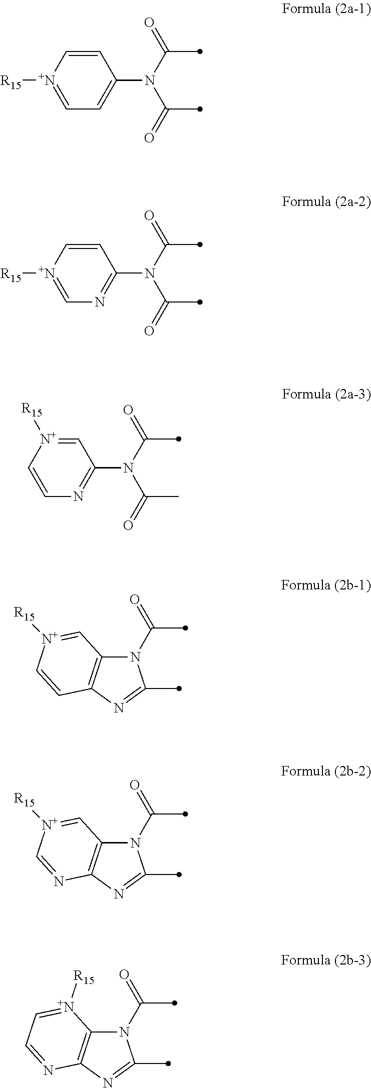

Typical examples of the lyotropic liquid crystalline compounds which can be used in the coating liquid of the present invention include compounds represented by formulae (3-1) to (3-20).

Incidentally, R₁ to R₁₅, Q₁, Q₂, n, and Xⁿ⁻ of the respective compounds in formulae (3-1) to (3-20) are the same as described above.

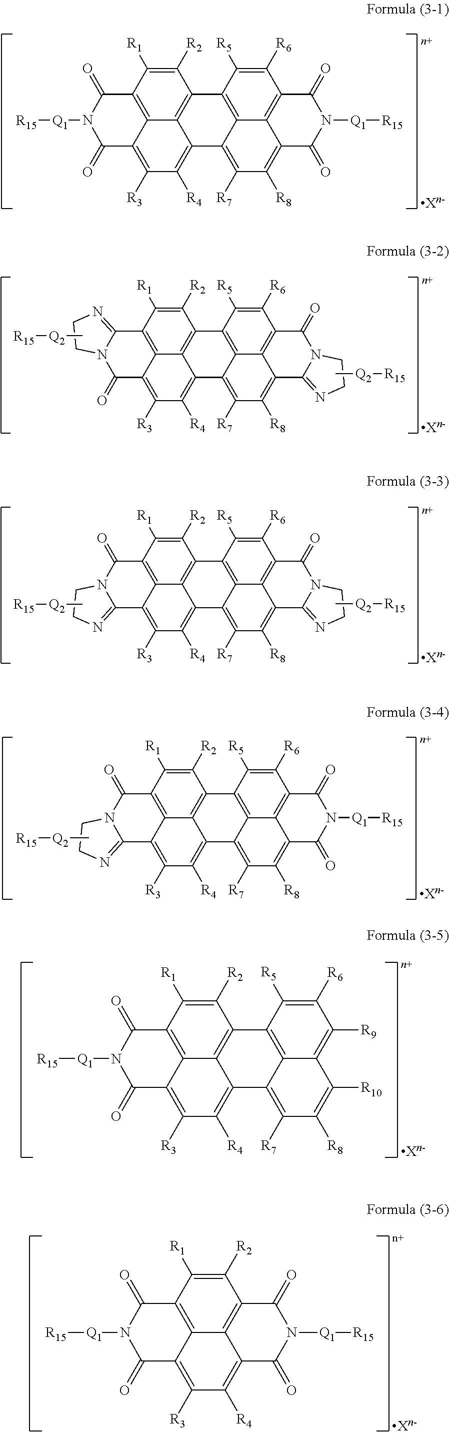

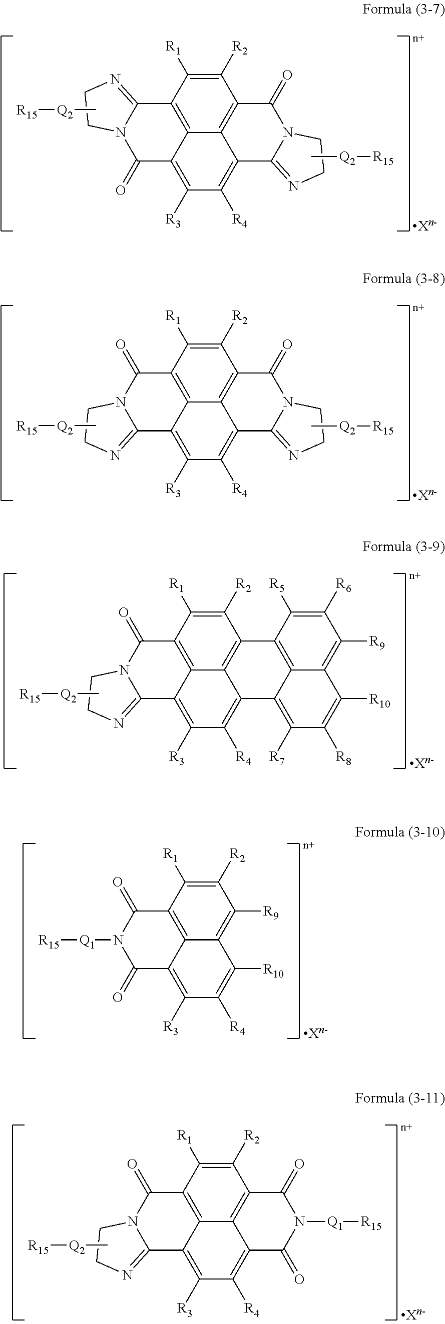

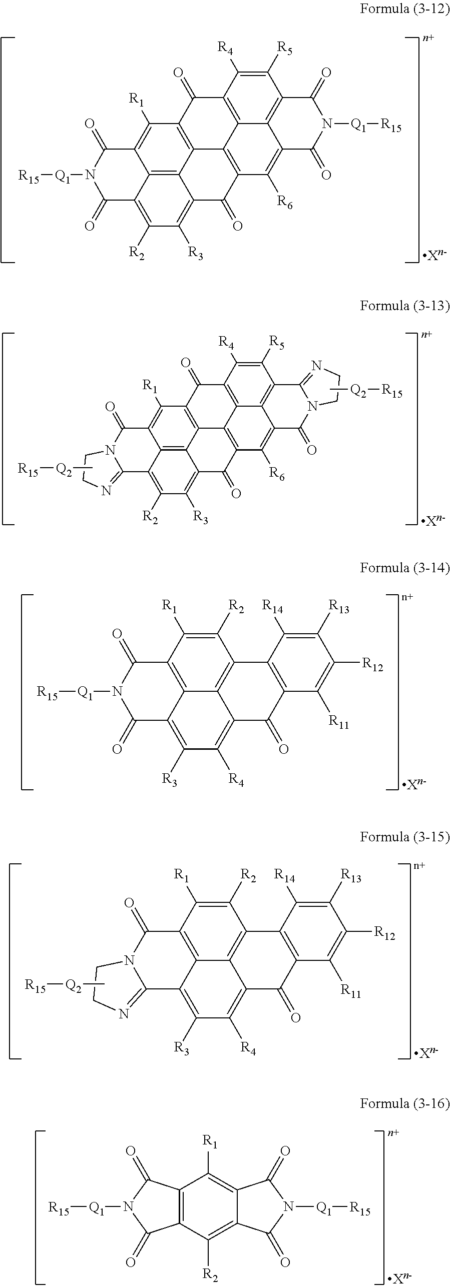

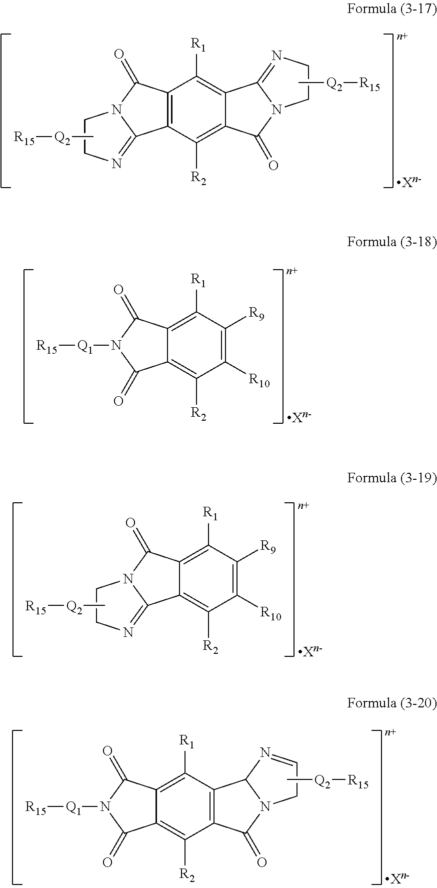

The above lyotropic liquid crystalline compound can be synthesized, for example, by the following method.

A compound having a π-conjugated system planar skeleton moiety (for example, a perylene-based compound or a naphthalene-based compound) is synthesized according to an ordinary method (Nobutomo Okawara, “Functional Dyes”, Mar. 10, 1992, published by Kodansha Ltd.), and thereafter, a nitrogen-containing heterocyclic ring or nitrogen-containing heteroaromatic ring is further bonded thereto. Then, this is reacted with hydrochloric acid or an alkyl halide compound, followed by ion exchange as needed, whereby the above lyotropic liquid crystalline compound can be obtained.

### (Solvent)

The solvent used in the present invention is not particularly limited, as long as it can dissolve the above lyotropic liquid crystalline compound.

The above lyotropic liquid crystalline compound has a heterocyclic cation moiety or heteroaromatic cation moiety, so that it is soluble in both of an aqueous solvent and an organic solvent. In particular, the above lyotropic liquid crystalline compound is excellent in solubility in the aqueous solvent. The aqueous solvents include water, a hydrophilic solvent and a mixed solvent of water and the hydrophilic solvent. The hydrophilic solvent is a solvent approximately homogenously compatible with water. Examples of the hydrophilic solvent include alcohols such as methanol, ethanol, and isopropyl alcohol; glycols such as ethylene glycol and diethylene glycol; cellosolves such as methyl cellosolve and ethyl cellosolve; ketones such as acetone and methyl ethyl ketone; and esters such as ethyl acetate. As the aqueous solvent, water or a mixed solvent of water and the hydrophilic solvent is preferably used.

### (Preparation of Coating Liquid)

The coating liquid of the present invention is obtained by dissolving the above lyotropic liquid crystalline compound in the above solvent.

The lyotropic liquid crystalline compound and the solvent are appropriately selected from the ones described above. The lyotropic liquid crystalline compounds and solvents may each be used either alone or in combination of two or more thereof.

Preferably, as the solvent, the aqueous solvent is used.

Preferably, as the lyotropic liquid crystalline compound, use can be made at least one selected from the compounds represented by formulae (1a) to (1d). More preferably, as the lyotropic liquid crystalline compound, use can be made at least one selected from the compounds represented by formulae (3-1) to (3-20), and particularly, at least one selected from the compounds represented by formulae (3-1) to (3-3) can be used suitably:

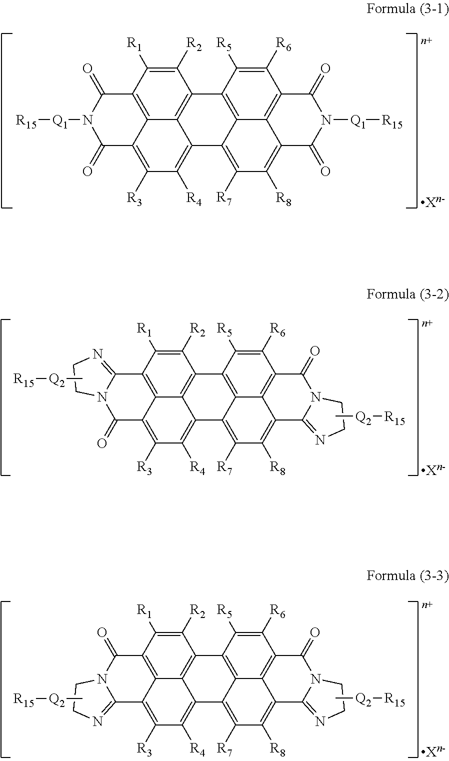

In the preparation of the coating liquid of the present invention, the lyotropic liquid crystalline compound may be added in the solvent, or the solvent may be poured on the lyotropic liquid crystalline compound.

The temperature of the solvent is preferably near room temperature, for example, about from 10 to 35° C.

The above lyotropic liquid crystalline compound is dissolved in the solvent by mixing the lyotropic liquid crystalline compound with the solvent. When the above lyotropic liquid crystalline compound is dissolved in the solvent, an anion is ionized to form a heterocyclic ring cation moiety or heteroaromatic ring cation moiety.

Although the concentration of the lyotropic liquid crystalline compound in the coating liquid is not particularly limited, it is preferably from 0.05 to 50 mass %, and more preferably from 0.5 to 40 mass %. The above lyotropic liquid crystalline compound can form a good liquid crystal phase within such a concentration range.

The coating liquid forms the liquid crystal phase by changing the liquid temperature thereof, the concentration of the lyotropic liquid crystalline compound or the like.

The liquid crystal phase is not particularly limited, and it may be a nematic liquid crystal phase, a middle liquid crystal phase, a smectic liquid crystal phase, a hexagonal liquid crystal phase or the like. The liquid crystal phase can be confirmed and identified by an optical pattern observed under a polarizing microscope.

Incidentally, an additive may be added to the coating liquid. Examples of the additives include a compatibilizing agent, a surfactant, a thermal stabilizer, an optical stabilizer, a lubricant, an antioxidant, an UV absorber, a flame retardant, an antistatic agent, and a thickener. The concentration of the additive in the coating liquid is preferably from more than 0 mass % and 10 mass % or less.

Further, a lyotropic liquid crystalline compound other than the above lyotropic liquid crystalline compound, a dye, a polymer or the like may be blended with the above coating liquid.

Further, the coating liquid is adjusted to a suitable pH. The pH of the coating liquid is preferably about from 2 to 10, and more preferably about from 6 to 8.

The above lyotropic liquid crystalline compound has the heterocyclic cation moiety or heteroaromatic cation moiety, so that it is excellent in solvent solubility. Further, the heterocyclic cation moiety or heteroaromatic cation moiety in the lyotropic liquid crystalline compound does not inhibit the planarity of the planar skeleton moiety. For this reason, the heterocyclic cation moiety or heteroaromatic cation moiety does not inhibit the stacking of the planar skeleton moieties of the lyotropic liquid crystalline compound, which are adjacent to each other, and rather promotes the stacking thereof. From the reason as described above, in the coating solution of the present invention, plural lyotropic liquid crystalline compound molecules form the stable columnar structure.

In a conventional lyotropic liquid crystalline compound in which a polar group-containing long-chain alkyl group is introduced, the polar group-containing long-chain alkyl group is bulky, so that it inhibits the stacking of the planar skeleton moieties. In this regard, in the lyotropic liquid crystalline compound used in the present invention, the stacking is easily performed, and further, the good columnar structure is formed, because the heterocyclic cation moiety or heteroaromatic cation moiety expands π-conjugation of the planar skeleton moiety.

Furthermore, the lyotropic liquid crystalline compound used in the present invention can be synthesized without using sulfuric acid, so that the synthesis thereof is also simple.

The coating liquid of the present invention in which the lyotropic liquid crystalline compound forms a good columnar structure can be used, for example, as a material for forming an optical anisotropic film. Further, the coating liquid can be used as a material for forming an organic semiconductor layer of a coating type organic electronic element.

### [Method for Producing Optical Anisotropic Film]

A method for producing an optical anisotropic film using the coating liquid of the present invention will be described below.

The optical anisotropic film of the present invention is obtained by film-forming the above liquid crystalline coating liquid by a solution casting method.

The optical anisotropic film can be produced, for example, through the following step A and step B, and step C may be performed after step B as needed.

Step A: A step of applying the coating liquid containing the above lyotropic liquid crystalline compound and solvent on a developing surface to form a coated film

Step B: A step of drying the coated film

Step C: A step of performing a water resistant treatment on a surface of the coated film dried in step B.

### (Step A)

The coating liquid prepared as described above is applied on an appropriate developing surface to form a coated film.

The developing surface is a surface for appropriately uniformly developing the coating liquid. The kind of developing surface is not particularly limited as long as this purpose is served. Examples of the developing surfaces include a surface of a polymer film, a surface of a glass substrate and a surface of a metal drum. A base material such as the polymer film or the glass substrate is preferably used as the developing surface. Further, a treatment such as an UV ozone treatment or a corona discharge treatment may be previously performed on the developing surface as needed.

The base material has preferably been given at least orientation-regulating force on the surface thereof, that is, an orientation base material is preferred. The base material having orientation-regulating force can surely orient the lyotropic liquid crystalline compound in the liquid. The orientation base material is obtained by giving orientation-regulating force to a surface of a base material. Methods for giving orientation-regulating force include, for example, a method of rubbing a surface of a base material with velvet cloth or the like; a method of forming a film of a polyimide or the like on a surface of a base material and rubbing a surface of the film; and a method of forming a film containing a photoreactive compound on a surface of a base material and irradiating the film with light to form an oriented film.

As the developing surface, a polymer film is preferably used, and a polymer film having excellent transparency (for example, having a haze value of 3% or less) is more preferred.

Examples of the material of the polymer films include polyester-based materials such as polyethylene terephthalate; cellulose-based materials such as triacetyl cellulose; polycarbonate-based materials; acrylic materials such as polymethyl methacrylate; styrenic materials such as polystyrene; and olefinic materials such as polypropylene and a cyclic or norbornene structure-containing polyolefin. In order to well orient the above lyotropic liquid crystalline compound, it is preferred to use a norbornene-based film.

Further, any organic material and/or any inorganic material may be laminated on the developing surface such as a surface of the above polymer film. The organic materials include azo compounds, phthalocyanine compounds, fullerenes, carbon nanotubes, graphenes, polythiophenes, and polyanilines. The inorganic materials include metals such as gold and aluminum, semiconductors such as silicon and GaN, and metal oxides such as ITO and TiO₂. A lamination method thereof is not particularly limited, and any known method can be employed.

A coating method of the coating liquid is not particularly limited, and for example, a coating method using a known coater can be employed. Examples of the coater include a bar coater, a roll coater, a spin coater, a comma coater, a gravure coater, an air knife coater, and a die coater.

When the coating liquid in a liquid crystalline phase state is applied on the developing surface, shear stress is applied to the lyotropic liquid crystalline compound in the course of flowing process of the coating liquid. Accordingly, the coated film with the columnar structure oriented can be formed on the developing surface. Incidentally, even when the coating liquid is in an isotropic phase state at the time of coating, the concentration thereof increases in the course of drying the coated film described later, resulting in that the plural lyotropic liquid crystalline compound molecules form the columnar structure.

Incidentally, in order to increase the orientation of the lyotropic liquid crystalline compounds, a magnetic field or an electric field may be applied thereto after the formation of the coated film, as needed.

### (Step B)

After the coating liquid is applied to form the coated film, this film is dried.

The drying of the coated film can be performed by natural drying or forced drying. The forced drying includes drying under reduced pressure, heating drying, and heating drying under reduced pressure.

In the course of drying the coated film, the concentration of the lyotropic liquid crystalline compound increases, and whereby the lyotropic liquid crystalline compound molecules forming the columnar structure are fixed. Further, even when the columnar structure is not formed at the time of coating, the concentration increases in the course of drying the coated film, and the lyotropic liquid crystalline compound molecules form the columnar structure and are fixed in that state.

The film obtained by drying and solidifying the coated film is the optical anisotropic film.

The thickness of the resulting optical anisotropic film is preferably from 0.05 μm to 10 μm, and more preferably from 0.1 μm to 5 μm.

### (Step C)

Incidentally, in order to give water resistance to the surface of the coated film after the above drying, the following treatment may be performed.

Specifically, a solution containing at least one salt (compound) selected from the group consisting of an aluminum salt, a barium salt, a lead salt, a chromium salt, a strontium salt, a cerium salt, a lanthanum salt, a samarium salt, a yttrium salt, a copper salt, an iron salt, and a salt (compound) having two or more amino groups in its molecule is brought into contact with the surface of the dried coated film.

A layer containing the above salt (compound) is formed on the surface of the dried coated film by performing this treatment. The surface of the dried coated film can be insolubilized or slightly-solubilized in water by forming such a layer. Accordingly, water resistance can be given to the dried coated film (optical anisotropic film).

When the above lyotropic liquid crystalline compound is a compound having absorption ability in a visible light region, the resulting optical anisotropic film can be utilized as a polarizing film. When the above lyotropic liquid crystalline compound is a compound having no absorption ability or small absorption ability in the visible light region, the resulting optical anisotropic film can be utilized as a phase difference film.

### (Uses, Etc. of Optical Anisotropic Film)

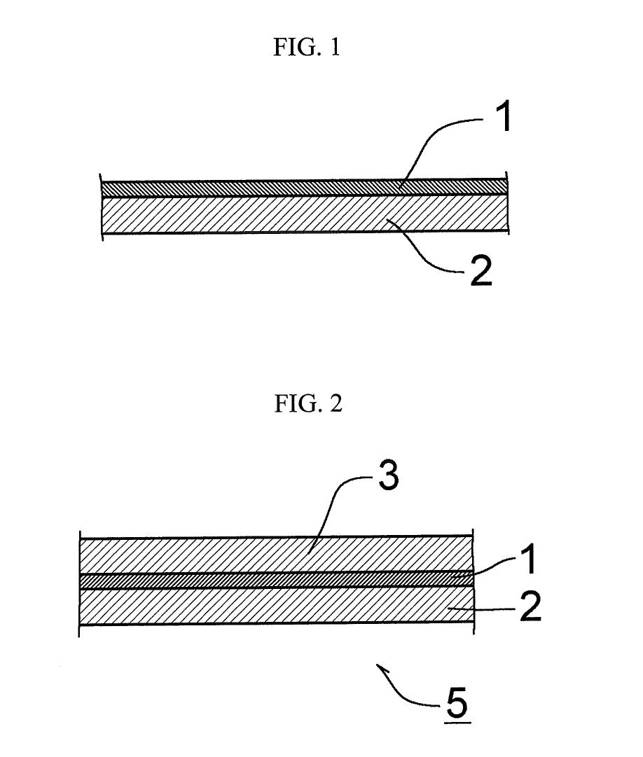

As shown in FIG. 1, the optical anisotropic film 1 formed from the above coating liquid is laminated on a base material 2 such as a polymer film.

The optical anisotropic film 1 is usually used in a state where it is laminated on the base material 2. However, it is also possible to use the optical anisotropic film 1 separated from the base material 2.

When the optical anisotropic film 1 is used as a polarizing film, as shown in FIG. 2, it is preferred that the optical anisotropic film 1 (polarizing film) is laminated with a protective film 3. A polarizing plate 5 can be formed by laminating the protective film 3 on the optical anisotropic film 1 laminated on the base material 2.

Uses of the optical anisotropic film of the present invention are not particularly limited. The optical anisotropic film of the present invention can be used, for example, as a constituent member of an image display device such as a liquid crystal display device or an organic EL display device.

When the above image display device is a liquid crystal display device, it is preferably used for a television, a portable device, a game instrument and the like.

### EXAMPLES

The present invention will be further described below with reference to Examples. However, the present invention should not be construed as being limited to the following Examples. Incidentally, respective analysis methods used in Examples are as follows

### [Method for Measuring Dichroic Ratio]

Using a spectrophotometer (manufactured by JASCO Corporation, product name: “V-7100”) equipped with a Glan Tompson polarizer, linearly polarized measuring light was subjected to enter the polarizing film for measurement, and k1 and k2 of a Y value corrected for luminosity were determined. The dichromic ratio was determined by substituting the k1 and k2 in the following equation, provided that the k1 represents the transmittance of linearly polarized light in a maximum transmittance direction of the polarizing film and that the k2 represents the transmittance of linearly polarized light in a direction perpendicular to the maximum transmittance direction.

Dichromic ratio=log(1/k2)/log(1/k1) Equation:

### [Observation Method of Liquid Crystal Phase]

A small amount of the coating liquid was sandwiched between two glass slides, and a liquid crystal phase thereof was observed using a polarizing microscope (manufactured by Olympus Corporation, product name: “OPTIPHOT-POL”) equipped with a large-sized sample heating/cooling stage for microscope (manufactured by Japan High Tech Co., Ltd., product: name “10013L”).

### [Method for Measuring Thickness of Polarizing Film]

For the thickness of the polarizing film, a part of the polarizing film formed on a norbornene-based polymer film was peeled, and the difference in thickness between the polymer film and the polarizing film was measured using a three-dimensional non-contact surface shape measuring system (manufactured by Ryoka Systems Inc., product name: “Micromap MM5200”).

### Synthesis Example 1 of Lyotropic Liquid Crystalline Compound

Into 50 ml of DMF, 1 g of perylenetetracarboxylic acid anhydride was dissolved, and to this was added 1 g of 4-aminopyridine, followed by heating at 140° C. to perform reaction, thereby obtaining 1.1 g of perylenetetracarboxylic acid diimide. After perylenetetracarboxylic acid diimide was isolated, to this was added 100 ml of iodomethane and allowed to react. Finally, iodine was converted to chloride ions using an ion exchange resin, thereby obtaining 0.7 g of perylene compound (N,N′-bis(4-N-methylpyridyl)-3,4,9,10-perylenecarboxylic acid diimide dichloride) having nitrogen-containing heterocyclic cation moieties represented by formula (4):

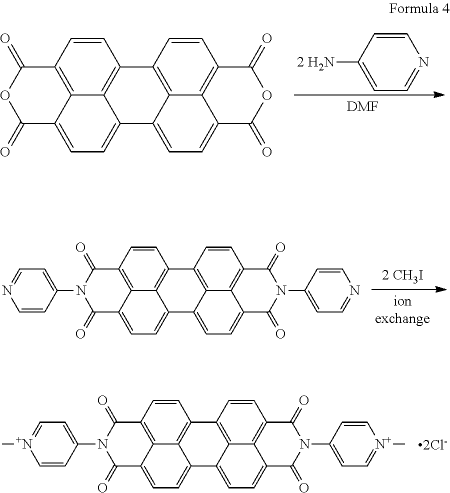

### Synthesis Example 2 of Lyotropic Liquid Crystalline Compound

A perylene compound having nitrogen-containing heterocyclic cation moieties represented by formula (5) was synthesized in the same manner as in the Synthesis Example 1 except that 1,2-diamino-4-pyridine was used in place of 4-aminopyridine.

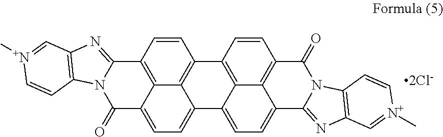

### Example 1

The lyotropic liquid crystalline compound of formula (4) was dissolved in ion-exchanged water, thereby preparing a coating liquid having a concentration of the lyotropic liquid crystalline compound of 30 mass %. In this case, the lyotropic liquid crystalline compound was dissolved in water easily and well. The coating liquid thus obtained was observed at 23° C. according to the above observing method of liquid crystal phase. As a result, it showed a nematic liquid crystal phase.

To the above obtained 30 mass % coating liquid was added ion-exchanged water to dilute it, and a coating liquid having a concentration of the lyotropic liquid crystalline compound of 5 mass % was finally prepared.

A surface of a norbornene-based polymer film (manufactured by Zeon Corporation, product name: “Zeonor”) was subjected to a rubbing treatment and a corona treatment, and the above final coating liquid was applied on the treated surface using a bar coater (manufacture by BUSHMAN Co., product name: “Mayer rot HS4”), followed by natural drying. A coated film after drying was a polarizing film.

The thickness of the polarizing film obtained was about 0.1 μm. The dichromic ratio of this polarizing film was measured. As a result, it was 3.2.

### Example 2

The lyotropic liquid crystalline compound of formula (5) was dissolved in ion-exchanged water, thereby preparing a coating liquid having a concentration of the lyotropic liquid crystalline compound of 30 mass %. In this case, the lyotropic liquid crystalline compound was dissolved in water easily and well. The coating liquid thus obtained was observed at 23° C. according to the above observing method of liquid crystal phase. As a result, it showed a nematic liquid crystal phase.

To the above obtained 30 mass % coating liquid was added ion-exchanged water to dilute it, and a coating liquid having a concentration of the lyotropic liquid crystalline compound of 5 mass % was finally prepared.

A polarizing film was prepared in the same manner as in Example 1 except that this final coating liquid was used.

The thickness of the polarizing film of Example 2 was about 0.1 μm, and the dichromic ratio thereof was 12.5.

### Comparative Example 1

In Comparative Example 1, there was used a perylenetetracarboxylic acid diimide represented by formula (6), which was an intermediate product in Synthesis Example 1 of Lyotropic Liquid Crystalline Compound. Using this compound, it was tried to obtain a coating liquid having a concentration of the lyotropic liquid crystalline compound of 30 mass % in the same manner as in Example 1. However, this compound was scarcely dissolved in ion-exchanged water. For this reason, this compound showed no liquid crystal phase.

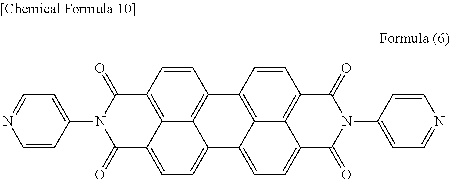

### Comparative Example 2

In Comparative Example 2, there was used a compound represented by formula (7), which was an intermediate product in Synthesis Example 2 of Lyotropic Liquid Crystalline Compound. Using this compound, it was tried to obtain a coating liquid having a concentration of the lyotropic liquid crystalline compound of 30 mass % in the same manner as in Example 1. However, this compound was scarcely dissolved in ion-exchanged water. For this reason, this compound showed no liquid crystal phase.

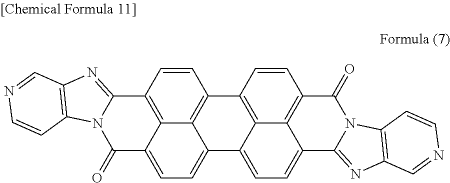

While the present invention has been described in detail and with reference to specific embodiments thereof, it will be apparent to one skilled in the art that various changes and modifications can be made therein without departing from the spirit and scope thereof.

The present application is based on Japanese patent application No. 2011-129864 filed on Jun. 10, 2011, the entire contents of which are incorporated hereto by reference. All references cited herein are incorporated in their entirety.

### INDUSTRIAL APPLICABILITY

The coating liquid of the present invention can be used as a material for forming an optical anisotropic film, a material for forming an organic semiconductor layer of a coating type organic electronic element, and the like.

### CITATION LIST

### Non-Patent Document

Non-Patent Document 1: Chem. Commun., 503-505 (2006)

### Patent Document

Patent Document 1: JP-T-2002-515075 (WO 1996/016015)

What is claimed is:

1. A coating liquid comprising:
a lyotropic liquid crystalline compound having a π-conjugated system planar skeleton moiety and one or plural nitrogen-containing heterocyclic cation moiety or nitrogen-containing heteroaromatic cation moiety bonded to the planar skeleton moiety; and a solvent.

2. The coating liquid according to claim 1, wherein the nitrogen-containing heterocyclic cation moiety or nitrogen-containing heteroaromatic cation moiety has a nitrogen atom having a conjugated double bond and constituting a heterocyclic ring as a cation.

3. The coating liquid according to claim 2, wherein an alkyl group is bonded to the nitrogen cation constituting the heterocyclic ring of the nitrogen-containing heterocyclic cation moiety or nitrogen-containing heteroaromatic cation moiety.

4. The coating liquid according to claim 3, wherein the alkyl group has from 1 to 4 carbon atoms.

5. The coating liquid according to claim 1, wherein the one or plural nitrogen-containing heterocyclic cation moiety or nitrogen-containing heteroaromatic cation moiety is bonded to an end portion of the π-conjugated system planar skeleton moiety.

6. The coating liquid according to claim 1, wherein the nitrogen-containing heterocyclic cation moiety or nitrogen-containing heteroaromatic cation moiety forms a part of the π-conjugated system planar skeleton moiety to expand the π-conjugated system planar skeleton moiety.

7. The coating liquid according to claim 1, wherein the lyotropic liquid crystalline compound comprises a compound represented by the following formula (1a), (1b), (1c) or (1d): 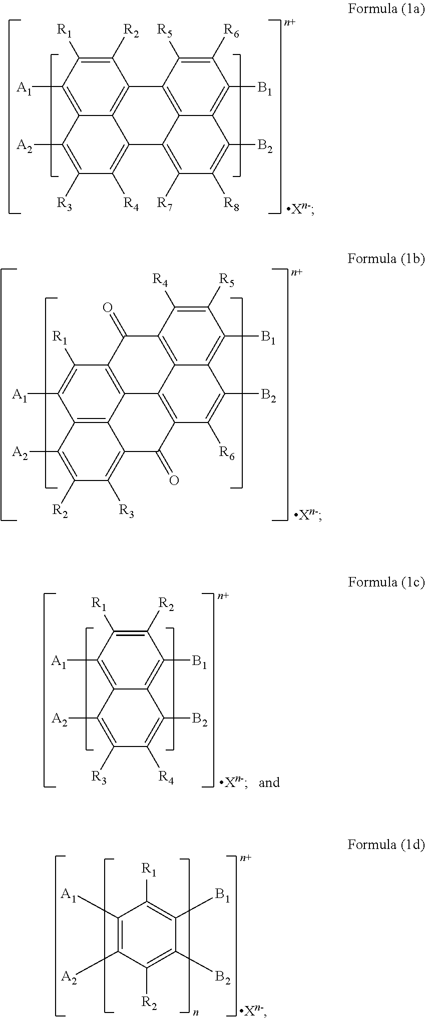
wherein n represents an integer of from 1 to 4, Xⁿ⁻ represents a counter ion, A₁ and A₂ represents that the group represented by the following formula (2a) or (2b) is bonded thereto to form a 5-membered or 6-membered ring, B₁ and B₂ each represents that the group represented by the following formula (2a), (2b) or (2c) is bonded thereto to form a 5-membered or 6-membered ring, or B₁ represents R₉ and B₂ represents R₁₀: 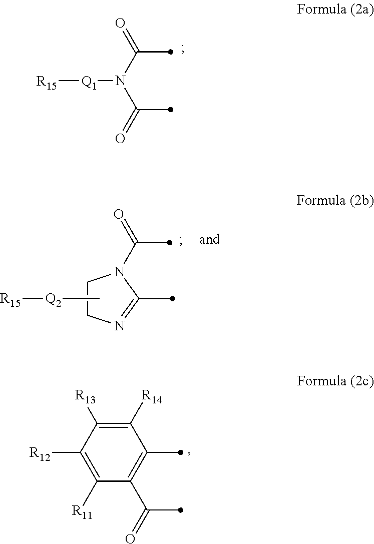
wherein Q₁ and Q₂ each independently represents a substituted or unsubstituted pyridinium, a substituted or unsubstituted pyrimidinium, a substituted or unsubstituted pyrazinium, a substituted or unsubstituted quinolinium, a substituted or unsubstituted isoquinolinium, a substituted or unsubstituted acridinium, a substituted or unsubstituted quinazolinium, a substituted or unsubstituted quinoxalinium, a substituted or unsubstituted imidazolium, a substituted or unsubstituted benzimidazolium, a substituted or unsubstituted indolium, or a substituted or unsubstituted triazinium, Q₂ may form a ring integral with the imidazoline ring to which it is bonded, R₁₅ represents a hydrogen atom, an alkyl group or an aryl group, which is bonded to the nitrogen cation of Q₁ or Q₂, and R₁ to R₁₄ each independently represents a hydrogen atom, a substituted or unsubstituted alkyl group, a substituted or unsubstituted alkoxy group, an acetyl group, a carbonyl group, a halogen atom, a substituted or unsubstituted ester group, an amide group, an allyloxy group, or an allyl group.

8. An optical anisotropic film obtained by applying the coating liquid according to claim 1 on a developing surface to form a coated film and solidifying this coated film.

9. An image display device provided with the optical anisotropic film according to claim 8.
